(19) United States
(12) Patent Application Publication
(10) Pub. No.: US 2026/0342793 A1
(43) Pub. Date: Oct. 29, 2026

(54) POLICY-BASED ATTESTATION OF OBJECTS

(71) Applicant: Hewlett Packard Enterprise Development LP, Spring, TX (US)

(72) Inventors: Isaac John Matthews, Bristol (GB); Nigel John Edwards, Bristol (GB)

(21) Appl. No.: 19/188,088

(22) Filed: Apr. 24, 2025

(51) Int. Cl. H04L 9/40

(52) U.S. Cl. CPC H04L 63/10; H04L 63/1408

(57) ABSTRACT

In some examples, an electronic device accesses policy information specifying identifiers of objects to be attested in the electronic device. The electronic device monitors the objects to detect an access of any object of the objects. Based on receiving an indication of an access of a first object of the objects, the electronic device measures the first object to produce an object measurement value and records the object measurement value in a security processor. The electronic device obtains a representation of the object measurement value for the first object from the security processor and sends the representation to an attestation server. The electronic device receives a result of an attestation of the first object from the attestation server.

### BACKGROUND

Electronic devices can operate in a computing environment, such as a workplace environment of an organization, a data center, a cloud environment, a home, or any other type of computing environment. Electronic devices may be vulnerable to attacks by attackers.

### BRIEF DESCRIPTION OF THE DRAWINGS

Some implementations of the present disclosure are described with respect to the following figures.

FIG. 1 is a block diagram of an arrangement including an electronic device and a server system, according to some examples.

FIG. 2 is a flow diagram of a process of collecting reference measurements, according to some examples.

FIG. 3 is a flow diagram of an attestation process in an operation phase, according to some examples.

FIG. 4 is a block diagram of a storage medium storing machine-readable instructions according to some examples.

FIG. 5 is a block diagram of an electronic device according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

When an electronic device initially boots, a boot time attestation of the electronic device can be performed to ensure the integrity of components (e.g., firmware, an operating system (OS) kernel, specific files such as configuration files containing configuration data or other files containing other information) of the electronic device. The collection of components that are attested at boot time of the electronic device is fixed. For example, portions of boot firmware, firmware configuration data and other static data, and the OS kernel are attested in a fixed sequence at boot time.

After the OS kernel is booted, further attestations of certain components at runtime of the electronic device may not be possible. Examples of components not attested at runtime include configuration files and/or interpreted files containing interpreted program code. A configuration file contains configuration data that defines a configuration of the electronic device. The interpreted program code of an interpretation file includes program code that can be executed directly without first having to compile the program code. For example, an interpreter can be provided to process the interpreted program code for execution. A configuration file is an example type of a static file that contains information governing an operation of the electronic device. Runtime attestation may also not be performed of other types of static files.

Components that are not attested at runtime may be compromised by attackers or by corruption caused by misbehaving programs or electronic components. For example, a compromised configuration file can lead to a misconfiguration of the electronic device. A compromised interpreted file can cause malicious or erroneous execution of program code. Such compromised components can lead to security risks and errors in the electronic device.

In accordance with some implementations of the present disclosure, a runtime attestation monitor is invoked in an electronic device to support attestation of objects during runtime of the electronic device. The runtime attestation monitor can access policy information specifying identifiers of objects to be attested in the electronic device. Examples of the objects can include configuration objects or other static objects containing information that govern an operation of the electronic device. The objects may also include interpreted objects containing interpreted program code. The runtime attestation monitor can apply measurements of the objects and record measurement values produced by the measurements in a security processor. The runtime attestation monitor can monitor the objects to detect an access of any object of the objects, and in response to receiving an indication of an access of a first object of the objects, the runtime attestation monitor can obtain a measurement value of the first object from the security processor. A representation of the obtained measurement value is sent from the electronic device to a verifier, which may be part of an attestation server reachable by the electronic device over a network. The electronic device receives the result of an attestation of the first object from the verifier.

Techniques or mechanisms according to some examples of the present disclosure can improve computer functionality or the relevant technology by attesting objects at runtime to prevent compromised objects from raising security risks or causing errors in an electronic device. Objects may be compromised by an attacker (e.g., malware, a human, or another attacker) in some cases. In other cases, objects may be compromised as a result of corruption due to erroneous operations of programs or electronic components. In some examples, a compromised configuration object can result in a misconfiguration of the electronic device, which may make the electronic device unavailable or which may allow an attacker to steal information or launch an attack against a computing environment. A compromised interpreted object can allow program code in the interpreted object to be modified in an unauthorized manner to allow an attacker to perform malicious actions. The ability to attest objects at runtime can detect the foregoing attacks.

A “runtime” of an electronic device can refer to a state of the electronic device after a boot process of the electronic device has completed. The boot process includes initializing the electronic device using boot code (e.g., boot firmware) in the electronic device, followed by the loading of an OS kernel in the electronic device.

An “object” can refer to a file, a table, a database, or any other container of information. An “identifier” of an object can refer to a name of the object (e.g., where the name can be part of a path in a file system), a uniform resource locator (URL), or any other type of identification information that distinguishes the object from another object.

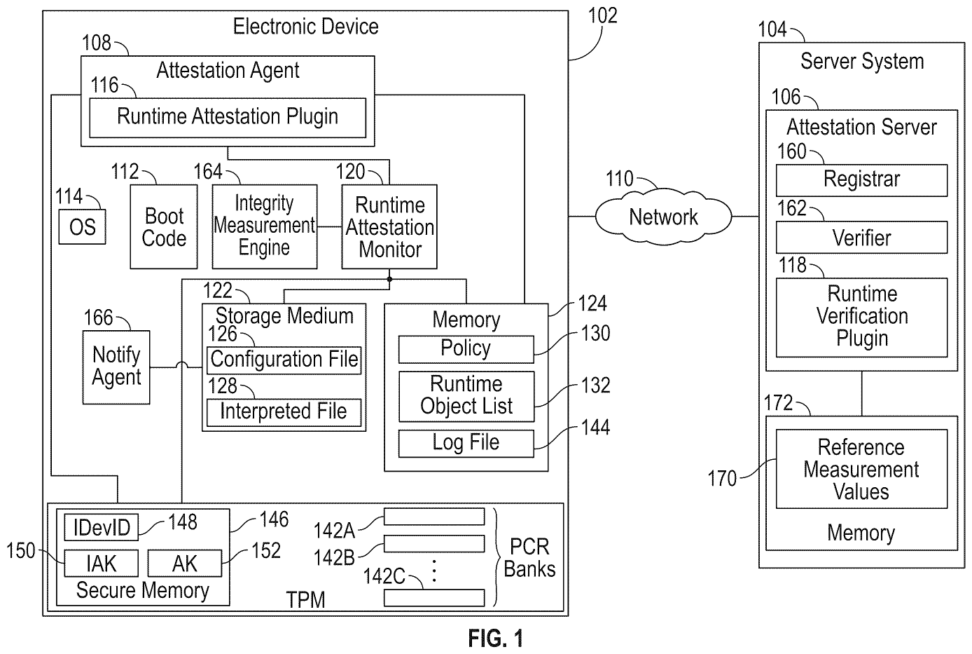

FIG. 1 is a block diagram of an example arrangement including an electronic device 102 and a server system 104 including an attestation server 106 that interacts with an attestation agent 108 in the electronic device 102 for performing attestation of objects in the electronic device 102. The server system 104 can include one or more computers. Although FIG. 1 shows just one electronic device 102, in further examples, multiple electronic devices can be attested by the attestation server 106 in the server system 104.

An “attestation” of an object includes applying a measurement of the object to verify the integrity of the object, i.e., the object has not been modified in an unintended manner such as due to an unauthorized modification by an attacker or a modification due to a faulty operation in the electronic device 102. The attestation server 106 includes machine-readable instructions executed by a processing resource of the server system 104, and the attestation agent 108 can include machine-readable instructions executed by a processing resource of the electronic device 102.

In some examples, the attestation agent 108 and the attestation server 106 operate according to an attestation protocol. In some examples, the attestation protocol can be an open-source protocol. In other examples, an attestation protocol can be a standardized protocol as set forth in a standards specification.

An example of an open-source attestation protocol is the Keylime protocol provided by the Cloud Native Computing Foundation (CNCF). The Keylime protocol supports a remote boot attestation and runtime integrity measurement system. Other examples of open-source attestation protocols include Project VERAISON (VERificAtion of atteStatiON) and Host Integrity at Runtime and Start-up (HIRS).

Other examples of attestation techniques can include any or some combination of the following: the Trusted Attestation Protocol (TAP) according to an information model provided by the Trusted Computing Group (TCG), or a standardized remote attestation protocol.

The electronic device 102 is coupled to the server system 104 over a network 110. The network 110 can include a public network such as the Internet, or alternatively, the network 110 can include a local area network (LAN), a wide area network (WAN), or any other type of network.

The electronic device 102 includes boot code 112 and an OS 114, which can be executed by the processing resource of the electronic device 102. The boot code 112 can include Basic Input/Output System (BIOS) code or Universal Extensible Firmware Interface (UEFI) code that initializes the electronic device 102 during a boot process of the electronic device 102. The OS 114 may include a LINUX OS, a WINDOWS OS, a MAC OS, or any other type of OS.

The attestation agent 108 includes a runtime attestation plugin 116, and the attestation server 106 includes a runtime verification plugin 118. A “plugin” refers to a program code component (including machine-readable instructions) that adds specific functionality to an existing program, where the specific functionality added by the plugin is not available in the existing program. The functionality added by the plugin can be added without having to modify the underlying existing program.

Thus, in the example of FIG. 1, the runtime attestation plugin 116 adds a functionality to the attestation agent 108, and the runtime verification plugin 118 adds functionality to the attestation server 106. The runtime attestation plugin 116 and the runtime verification plugin 118 add functionalities to allow the attestation agent 108 and the attestation server 106 to perform runtime attestation of objects in the electronic device 102.

In an example, the attestation agent 108 and the attestation server 106 may operate according to the Keylime protocol. A version of the Keylime protocol may not support runtime attestations of objects in electronic devices. The runtime attestation plugin 116 and the runtime verification plugin 118 can add runtime attestation functionalities to the Keylime attestation agent and attestation server.

In other examples, instead of using plugins, the attestation agent 108 and the attestation server 106 may be configured to support runtime attestations of objects according to some implementations of the present disclosure.

In some examples of the present disclosure, the electronic device 102 includes a runtime attestation monitor 120 that applies measurements of objects to support the attestation of the objects during runtime of the electronic device 102. In an example, the runtime attestation monitor 120 (including machine-readable instructions) can execute in the user space of the electronic device 102. The user space is distinct from the kernel space in which a kernel of the OS 114 executes.

The runtime attestation monitor 120 can access a storage medium 122 and a memory 124. The storage medium 122 can be a persistent storage medium, which can be implemented using one or more storage devices such as disk-based storage devices, solid-state drives, or other types of storage devices. The memory 124 can be implemented using one or more memory devices.

According to the example of FIG. 1, the objects that are to be attested during runtime include a configuration file 126 containing configuration data, and an interpreted file 128 containing interpreted program code. Although two specific files are shown in FIG. 1, in other examples, alternative or additional objects may be attested using measurement values provided by the runtime attestation monitor 120. The runtime attestation monitor 120 extends the chain of trust to objects, such as the configuration file 126 and the interpreted file 128, that would not normally be attested at runtime.

The memory 124 stores a runtime attestation policy 130 that specifies identifiers (e.g., names, URLs, etc.) of objects (including the configuration file 126 and the interpreted file 128) that are to be attested at runtime of the electronic device 102. The runtime attestation policy can derive, using the identifiers, storage locations (in the storage medium 122) of objects that are to be attested. For example, if the name of an object is part of a path in a file system, the path and name can be used to access the object. As another example, a URL can indicate a storage location of an object.

The runtime attestation monitor 120 parses the runtime attestation policy 130 to generate a runtime object list 132 of objects that are to be attested. A “list” can refer to a data structure that includes one or more elements, such as identifiers of objects to be attested.

Based on the runtime object list 132, the runtime attestation monitor 120 applies measurements of the objects to be attested, including the configuration file 126 and the interpreted file 128. Measurement values produced by the measurements of the objects to be attested can be recorded in registers of a security processor, such as Platform Configuration Registers (PCRs) of a trusted platform module (TPM) 140. The TPM 140 can perform various hardware-based, security functions in the electronic device 102. In other examples, the TPM 140 may be implemented in software, such as in the form of a virtual TPM (which is an example of a virtual security processor). The TPM 140 functions as a root of trust in addition to support for cryptographic functionalities. The security functions of the TPM 140 can include key and certificate management and generation. For example, the TPM 140 can generate cryptographic keys used in security operations, where a cryptographic key can include a public-private key pair including a public key and the associated private key.

A PCR in the TPM 140 is a storage location to store certain values, such as measurements (e.g., hash values) of information (e.g., objects to be attested including the configuration file 126 and the interpreted file 128) in the electronic device 102. In an example, the runtime attestation monitor 120 can apply a cryptographic hash function, such as a Secure Hash Algorithm (SHA) function, to the information to produce hash values that can be extended to a PCR. The measurement agent extends a PCR by performing an extend operation that calculates a cryptographic hash of a combination of the current value in the PCR with a new hash value.

The PCRs of the TPM 140 are arranged in PCR banks 142A, 142B, and 142C. Although 3 PCR banks are shown in FIG. 1, in a different example, a different quantity of PCR banks may be present in the TPM 140. A PCR bank can include a collection of PCRs.

In the ensuing discussion, it is assumed that measurement values for the configuration file 126 and the interpreted file 128 are extended to the PCR bank 142A. More generally, measurement values for objects to be attested can be extended to one or more PCR banks 142. For example, if the TPM 140 supports multiple cryptographic hash algorithms to calculate hash values, different PCR banks can be used to record hash values produced using respective different cryptographic hash algorithms.

Along with extending the measurement values for the configuration file 126 and the interpreted file 128 to the PCR bank 142A, the runtime attestation monitor 120 also adds the measurement values of the configuration file 126 and interpreted file 128 to a log file 144. The log file 144 (or any other log data structure) is stored by the runtime attestation monitor 120 in the memory 124. Each entry of the log file 144 can include an identifier of an object along with the corresponding measurement value.

Note further that the runtime attestation monitor 120 also applies a measurement of the runtime attestation policy 130, and extends the measurement value for the runtime attestation policy 130 to the PCR bank 142A (or another PCR bank) and adds the measurement value for the runtime attestation policy 130 to the log file 144. The entry in the log file 144 for the runtime attestation policy 130 includes an identifier of the runtime attestation policy 130 and the measurement value for the runtime attestation policy 130.

The TPM 140 includes a secure memory 146 that stores key information. For example, the TPM's secure memory 146 can store a private key of a cryptographic device identity such as a Device Identity (DevID) certificate. The DevID certificate can be an Initial DevID (IDevID) certificate 148 installed in the electronic device 102 at the time of manufacture of the electronic device 102. Another example of the cryptographic device identity is a Local DevID (LDevID) certificate. DevIDs are explained further in Institute of Electrical and Electronics Engineers (IEEE) 802.1AR Secure Device Identity standard. The IDevID or LDevID certificate may be stored in the memory 124 of the electronic device 102 in some examples. In other examples, a certificate is not stored in the electronic device 102, but may be part of an inventory of certificates available to the server system 104.

A “certificate” (also referred to as a “digital certificate”) refers to information (e.g., a file or another object) that is used to prove the authenticity of an entity, such as a user, a program, or a device. A certificate may be an X.509 certificate. A certificate can include information about an entity (e.g., a user, a program, or a device), and is issued by a trusted third party, such as a certificate authority (CA).

In some examples, the TPM's secure memory 146 can further store an initial attestation key (IAK) 150. The TPM 140 may create further attestation keys (AKs), such as an AK 152, which may be stored in the secure memory 146. The AK 152 can be used to sign data of the TPM 140 for attesting the electronic device 102.

Although specific examples of certificates and keys are shown in FIG. 1, in other examples, the TPM's secure memory 146 can store other types of certificates and/or keys.

The electronic device 102 further includes an integrity measurement engine 164, which can be used to confirm the integrity of specific components, such as the runtime attestation monitor 120 or any other component of the electronic device 102. In an example, the integrity measurement engine 164 can be according to the Integrity Measurement Architecture (IMA) provided by a LINUX OS. In other examples, other types of integrity measurement engines can be used in association with other types of OSes. The integrity measurement engine 164 can perform a measurement of the runtime attestation monitor 120.

The electronic device 102 further includes a notify agent 166 (including machine-readable instructions) that can notify the runtime attestation monitor 120 of any access (e.g., read or write) of an object in the runtime object list 132. Based on this notification from the notify agent 166 when an object in the runtime object list 132 is accessed, the runtime attestation monitor 120 can take a further measurement of the accessed object (e.g., the configuration file 126 or the interpreted file 128) to start a runtime attestation of the accessed objects with the attestation server 106. The runtime attestation monitor 120 extends the further measurement value to the PCR bank 142A, and adds the further measurement value to the log file 144.

The attestation server 106 includes a registrar 160 which the attestation agent 108 can register with. Once the attestation agent 108 has registered with the registrar 160, the attestation agent 108 can perform an attestation process with a verifier 162 in the attestation server 106. The registrar 160, the verifier 162, and the runtime verification plugin 118 include machine-readable instructions that are part of the attestation server 106.

In accordance with some examples of the present disclosure, the attestation agent 108 can use keys that are stored in the TPM 140 without having to regenerate the keys. For example, the Keylime protocol specifies that keys are to be regenerated at runtime before a registration process can be performed with a Keylime attestation server. For example, the regenerated keys are according to specified templates provided by the IDevID/IAK Specification. In contrast, keys stored in a TPM may have a custom template that differs from the specified template.

In some examples of the present disclosure, the attestation agent 108 can be configured to support the use of keys in the TPM 140 (or any other type of security processor) without having to regenerate the keys. The keys in the TPM 140 include keys of the IDevID certificate 148, the IAK 150, and the AK 152. Regenerating keys is a resource intensive and time-consuming process.

Keys stored in the TPM's secure memory 146 can also be protected using a password, such as a hexadecimal password, or another credential. The attestation agent 108 is configured to support use of such a password (or another credential) to access keys from the TPM's secure memory 146.

Thus, instead of regenerating keys, the attestation agent 108 can collect the IDevID and IAK keys, by using TPM handles (which are addresses identifying locations in the TPM 140) referring to where the keys are stored. The attestation agent 108 can issue a password (or another credential) to access such keys at the respective TPM handles. The attestation agent 108 can perform registration with the registrar 160 in the attestation server 106 using IDevID.

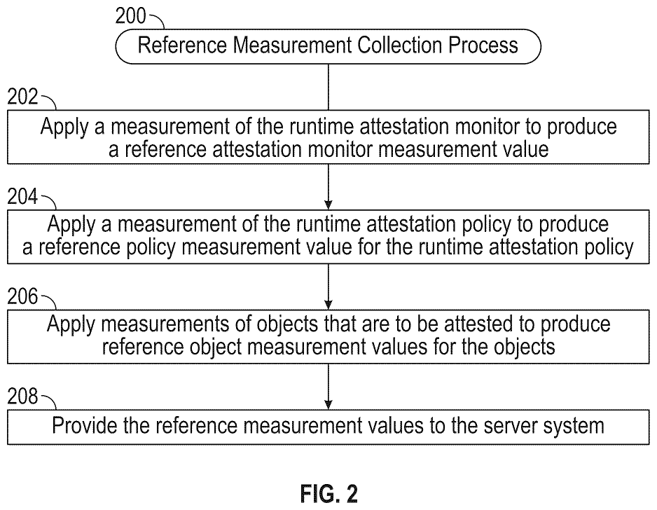

The following refers to both FIG. 1 and FIG. 2. FIG. 2 is a flow diagram of a reference measurement collection process 200 to collect reference measurements. The reference measurement collection process 200 can be performed by a reference measurement program executed in the electronic device 102 or outside the electronic device 102, for example. The reference measurement collection process 200 is performed in an initial phase during manufacture or at a different time when the electronic device 102 is in a secure location or in a secure state.

The reference measurement program applies (at 202) a measurement of the runtime attestation monitor 120 to produce a reference attestation monitor measurement value, such as a hash value produced by applying the cryptographic hash function to the runtime attestation monitor 120.

The reference measurement program applies (at 204) a measurement of the runtime attestation policy 130 to produce a reference policy measurement value (e.g., a hash value) for the runtime attestation policy 130. The reference measurement program further applies (at 206) measurements of objects, including the configuration file 126 and the interpreted file 128, that are to be attested to produce reference object measurement values (e.g., hash values) for the objects.

The reference measurement program provides (at 208) the reference measurement values (including the reference attestation monitor measurement value, the reference policy measurement value, and the reference object measurement values) to the server system 104. The server system 104 stores the reference measurement values (represented as 170) in a memory 172 of the server system 104.

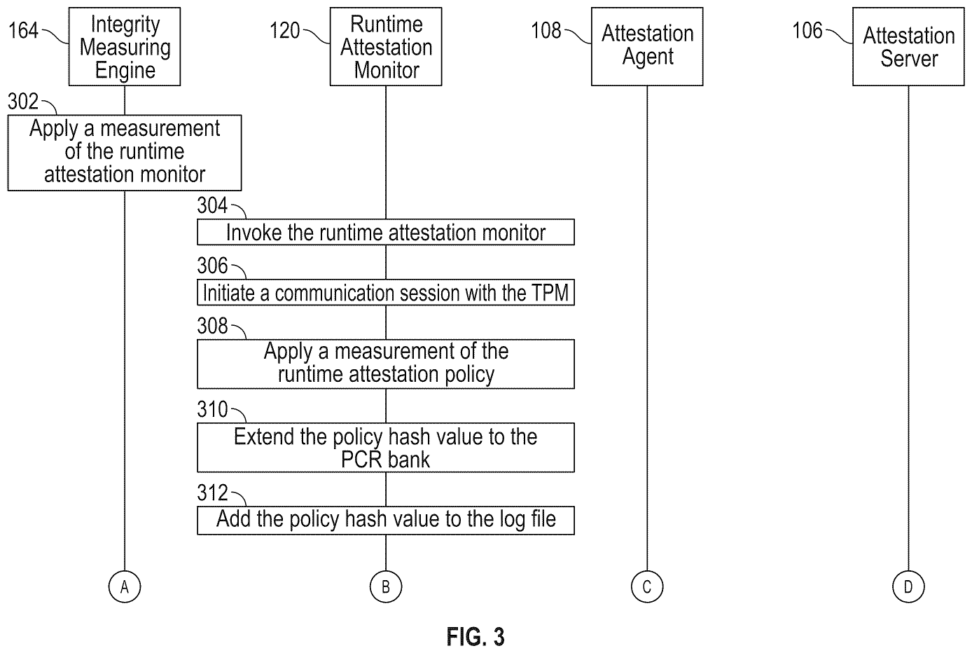

The following refers to both FIG. 1 and FIG. 3. FIG. 3 is a flow diagram of a process involving the integrity measurement engine 164, the runtime attestation monitor 120, the attestation agent 108, and the attestation server 106. The process of FIG. 3 is performed in an operation phase of the electronic device 102. The operation phase is performed during an operation of the electronic device 102 after delivery to a customer site or to another site at which the electronic device 102 is to be operated for its intended purposes.

The electronic device 102 is started by the boot code 112 when the electronic device 102 is first powered on or is rebooted. The boot code 112 loads the OS 114. The electronic device 102 enters the runtime state after the OS 114 is loaded.

Before invoking the runtime attestation monitor 120, the integrity measurement engine 164 applies (at 302) a measurement of the runtime attestation monitor 120 to produce a monitor measurement value, which is added to a log file (not shown) for the integrity measurement engine 164. The log file for the integrity measurement engine 164 can be different from the log file 144. The log file containing the monitor measurement value is provided to the attestation server to verify that the runtime attestation monitor 120 has not been compromised, either intentionally by an attacker or unintentionally due to an error in the electronic device 102. For example, the integrity measurement engine 164 can apply a cryptographic hash function on the runtime attestation monitor 120 to derive a hash value that is added to the log file for the integrity measurement engine 164 and provided to the attestation server 106. Alternatively, the integrity measurement engine 164 can compare the derived hash value to a reference hash value to ensure that the runtime attestation monitor 120 has not been modified in an unauthorized manner.

The runtime attestation monitor 120 is invoked (at 304), such as by the OS 114. The runtime attestation monitor 120 discovers the TPM 140 and initiates (at 306) a communication session with the TPM 140, which can be accomplished by initiating a TPM context to interact with the TPM 140. The TPM context is an object that contains a connection configuration for communicating with the TPM 140. The TPM context also contains information about content in the TPM 140. The runtime attestation monitor 120 can discover the TPM 140 by accessing configuration information stored in the electronic device 102, for example.

In some examples, the runtime attestation monitor 120 can discover a collection of cryptographic hash algorithms used by the TPM 140, based on the information in the TPM context. In such examples, the runtime attestation monitor 120 can apply hash functions of the cryptographic hash algorithms on selected information, including objects to be attested as identified by the runtime object list 132, to record in respective TPM banks. However, in the ensuing discussion, reference is made to use of just one cryptographic hash algorithm for measuring objects to be attested, to simplify the explanation.

The runtime attestation monitor 120 applies (at 308) a measurement of the runtime attestation policy 130 to produce a policy measurement value for the runtime attestation policy 130. The measurement can include applying a cryptographic hash function to the runtime attestation policy 130, to produce a policy hash value. The runtime attestation monitor 120 extends (at 310) the policy hash value to the PCR bank 142A, and adds (at 312) the policy hash value to the log file 144. The policy hash value for the runtime attestation policy 130 is provided to the attestation server 106 for checking that the runtime attestation policy 130 has not been compromised.

The runtime attestation monitor 120 parses the runtime attestation policy 130 to derive (at 314) the runtime object list 132 of objects that are to be attested at runtime. The runtime attestation monitor 120 sets up a watch of the objects identified by the runtime object list 132 using the notify agent 166. In some examples, the notify agent 166 can include an inotify subsystem of the LINUX OS. The runtime attestation monitor 120 provides a reference to the runtime object list 132 to the notify agent 166, which monitors the objects identified by the runtime object list 132 to detect any access of the objects. In alternative examples, instead of using a separate notify agent 166, the runtime attestation monitor 120 can itself monitor for an access of any of the objects identified by the runtime object list 132.

In response to detecting an access of an object identified by the runtime object list 132, the notify agent 166 sends a notification to the runtime attestation monitor 120. In response to receiving (at 316) the notification, the runtime attestation monitor 120 applies (at 318) a measurement of the accessed object, to derive an object measurement value (e.g., an object hash value). The runtime attestation monitor 120 extends (at 320) the object hash value to the PCR bank 142A, and adds (at 322) the object hash value to the log file 144.

Note that if multiple objects are accessed, then the runtime attestation monitor 120 applies measurements of the multiple objects to derive respective object measurement values (e.g., object hash values) that are extended to the PCR bank 142A and added to the log file 144. In alternative examples, the runtime attestation monitor 120 may also apply measurements of non-accessed objects along with measurements of accessed object(s), and the object measurement values (e.g., object hash values) for the non-accessed objects are also extended to the PCR bank 142A and added to the log file 144.

The following discussion assumes there is just one object hash value for one accessed object extended to the PCR bank 142A and added to the log file 144. Similar techniques can be applied if multiple object hash values are extended to the PCR bank 142A and added to the log file 144.

The runtime attestation monitor 120 next provides (at 324) an indication (e.g., a message, a command, an information element, or any other indicator) to the attestation agent 108 that an attestation is to be performed, which in this example is an attestation of the accessed object (e.g., one or both of the configuration file 126 and the interpreted file 128). The attestation agent 108 obtains (at 326) attestation data based on the policy hash value and object hash value from the PCR bank 142A using a TPM PCR read command. The TPM PCR read command reads the current PCR value contained in the PCR bank 142A.

The runtime attestation plugin 116 of the attestation agent 108 obtains (at 328) the log file 144. In some examples, the attestation agent 108 (e.g., a Keylime attestation agent) may not be able to obtain the log file 144 for purposes of performing runtime attestation. In such examples, the runtime attestation plugin 116 can add the functionality of obtaining the log file 144 for runtime attestation. Note that the runtime attestation plugin 116 can also select the PCR bank(s) that the attestation agent 108 is to access for the runtime attestation. In other examples, the runtime attestation plugin 116 can be omitted and the attestation agent 108 can obtain both the attestation data from the PCR bank 142A and the log file 144.

The attestation agent 108 sends (at 330) the attestation data and the log file 144 to the attestation server 106. The attestation data may be included in a signed PCR quote (signed with the private key of the AK 152) from the attestation agent 108 to the attestation server 106. The signed PCR quote may be pushed by the attestation agent 108 to the attestation server 106, or alternatively, the signed PCR quote may be sent by the attestation agent 108 in response to a PCR quote request from the attestation server 106.

In some examples, the verifier 162 of the attestation server 106 (e.g., a Keylime attestation server) can perform attestations of certain components of the electronic device 102, such as boot code, boot information, and other components. However, the verifier 162 may not be configured to perform runtime attestation of objects identified by the runtime object list 132. Instead, the runtime verification plugin 118 can perform the runtime attestation of the objects identified by the runtime object list 132. In other examples, the runtime attestation can be performed by the verifier 162.

The runtime verification plugin 118 determines (at 332), based on the received attestation data and the log file 144, an integrity of the accessed object. The runtime verification plugin 118 validates the signed PCR quote using the public key of the AK 152). If the PCR quote is valid, in some examples, the runtime verification plugin 118 can perform a PCR replay based on the hash values contained in the log file 144. The log file 144 contains the following hash values: the policy hash value and the object hash value (of the accessed object). Performing the PCR replay based on the log file 144 involves deriving PCR values based on simulating the PCR extend operation using the hash values in the log file 144. The derived PCR value is compared to the PCR value contained in the attestation data received from the attestation agent 108. If the derived PCR value matches the PCR value contained in the attestation data, then the integrity of the log file 144 is confirmed. If the integrity of the log file 144 is confirmed, the runtime verification plugin 118 further compares the policy hash value in the log file 144 to the reference policy hash value, and the object hash value in the log file 144 to the respective reference object hash value. The reference policy hash value and the reference object hash value are part of the reference measurement values 170 stored in the memory 172 of the server system 104. If the policy hash value and the object hash value in the log file 144 match the reference policy hash value and the reference object hash value, respectively, then the integrity of the runtime attestation policy 130 and the accessed object is confirmed, and the attestation succeeds. If either the policy hash value or the object hash value in the log file 144 does not match the respective reference policy hash value or reference object hash value, then the runtime attestation policy 130 or the accessed object has been compromised, and the attestation fails.

The attestation server 106 sends (at 334), to the attestation agent 108, information indicating the result of the attestation. If the attestation is successful, the attestation agent 108 can allow the electronic device 102 to continue to operate. However, if the attestation failed, then the attestation agent 108 can cause the electronic device 102 to be disabled. For example, the attestation agent 108 can send an indication of attestation failure to a management controller, the OS 114, or another component in the electronic device 102 to disable the electronic device 102, such as shutting down the electronic device 102, removing power from the electronic device 102, or disabling software or firmware in the electronic device 102. The electronic device 102 may also be isolated from the network 110, to prevent communications between the electronic device 102 and other devices. The isolation may be accomplished by disabling the network interface of the electronic device 102, or notifying other devices that the electronic device 102 is compromised.

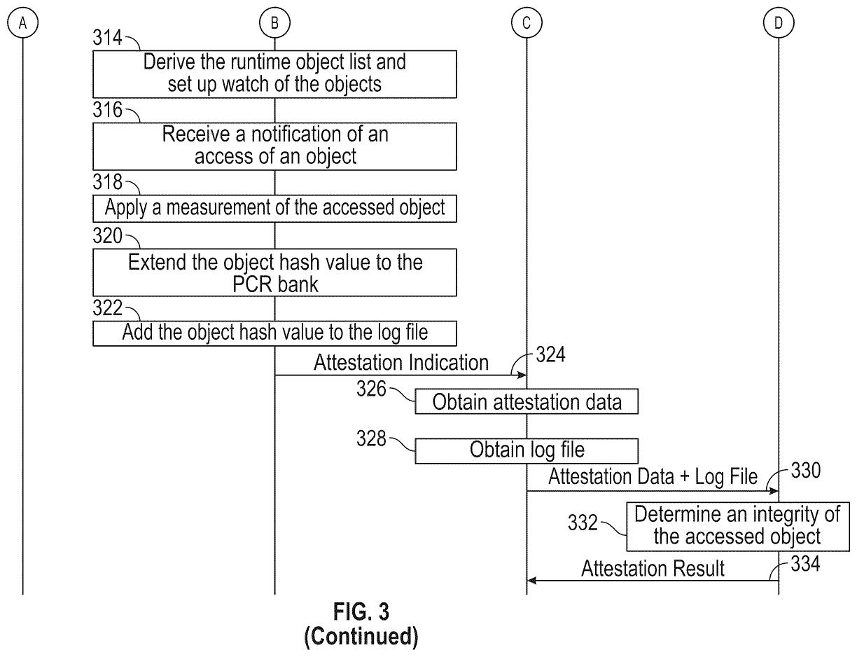

FIG. 4 is a block diagram of a non-transitory machine-readable or computer-readable storage medium 400 storing machine-readable instructions that upon execution cause an electronic device to perform various tasks.

The machine-readable instructions include runtime policy access instructions 402 to access policy information specifying identifiers of objects to be attested in the electronic device. The policy information may be the runtime attestation policy 130 of FIG. 1, for example. The identifiers may include names, URLs, or other forms of identification information of specific objects subject to runtime attestation, for example.

The machine-readable instructions include object monitoring instructions 404 to monitor the objects to detect an access of any object of the objects. The monitoring may be performed by the notify agent 166 of FIG. 1, or by the runtime attestation monitor 120 of FIG. 1.

The machine-readable instructions include accessed object measurement instructions 406 to, based on receiving an indication of an access of a first object of the objects, measure the first object to produce an object measurement value and record the object measurement value in a security processor. For example, the security processor may include a TPM, and recording the object measurement value includes extending a PCR (one or more PCRs) of the TPM using the object measurement value. In further examples, measurements of multiple objects can be performed to produce multiple object measurement values that are recorded in the security processor (e.g., extended to the PCR).

The machine-readable instructions include object measurement representation obtaining and sending instructions 408 to obtain a representation of the object measurement value for the first object from the security processor and send the representation to an attestation server. The representation of the object measurement value may be included in a signed PCR quote, for example.

The machine-readable instructions include attestation result reception instructions 410 to receive a result of an attestation of the first object from the attestation server. The attestation server may execute in a server system that is separate from the electronic device.

In some examples, the machine-readable instructions to access the policy information, monitor the objects, measure the first object, obtain the representation of the object measurement value for the first object, and send the representation to the attestation server are in a user space of the electronic device. These machine-readable instructions may be part of the runtime attestation monitor 120 of FIG. 1, for example.

In some examples, the monitoring of the objects, the measurement of the first object, the obtaining of the representation of the object measurement value for the first object, and the sending of the representation to the attestation server are performed during a runtime of the electronic device.

In some examples, the accessing of the policy information, the monitoring of the objects, the measuring of the first object, and the obtaining of the representation of the object measurement value for the first object are performed by a runtime attestation monitor invoked in response to a boot of the electronic device.

In some examples, the runtime attestation monitor can discover the security processor, and establish a communication session with the security processor.

In some examples, an integrity measurement engine (e.g., 164 in FIG. 1) in the electronic device can measure the runtime attestation monitor to verify that the runtime attestation monitor has not been compromised.

In some examples, the runtime attestation monitor can measure the policy information to obtain a policy measurement value for the policy information, and the electronic device can send a representation of the policy measurement value for the policy information to the attestation server to verify that the policy information has not been compromised.

In some examples, the electronic device can create a log including the object measurement value for the first object, and the electronic device can send the log with the representation of the object measurement value to the attestation server.

In some examples, the attestation of the first object by the attestation server includes performing a PCR replay using the log, and comparing the object measurement value in the log file to a reference object measurement value.

In some examples, the representation of the object measurement value is sent by an attestation agent in the electronic device to the attestation server, where the attestation agent and the attestation server operate according to an open-source attestation protocol.

In some examples, the open-source attestation protocol is a Keylime protocol.

In some examples, the attestation agent can register, using a device identity certificate (e.g., IDevID), with a registrar that operates according the open-source attestation protocol. The registrar can be part of the attestation server.

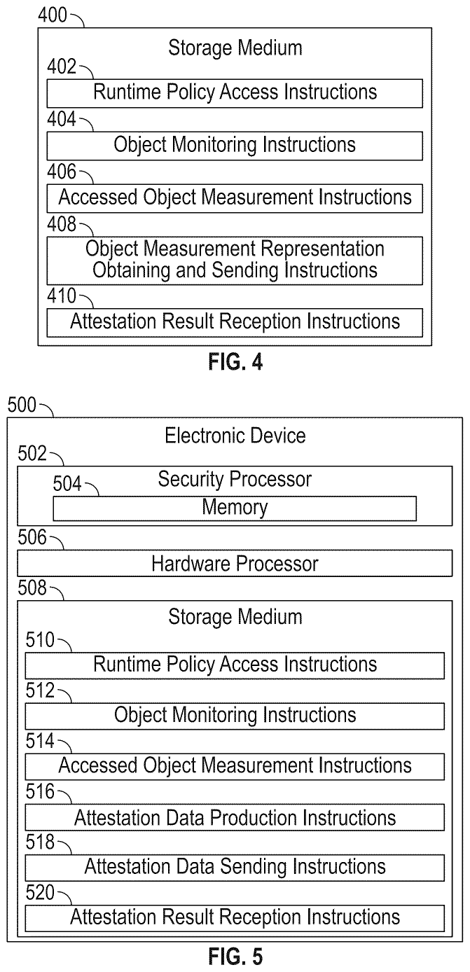

FIG. 5 is a block diagram of an electronic device 500. The electronic device 102 of FIG. 1 is an example of the electronic device 500.

The electronic device 500 includes a security processor 502 having a memory 504. The security processor 502 may include a TPM, and the memory 504 may include a PCR of the TPM.

The electronic device 500 includes a hardware processor 506 (or multiple hardware processors). A hardware processor can include a microprocessor, a core of a multi-core microprocessor, a microcontroller, a programmable integrated circuit, a programmable gate array, or another hardware processing circuit.

The electronic device 500 includes a storage medium 508 storing machine-readable instructions executable on the hardware processor 506 to perform various tasks. Machine-readable instructions executable on a hardware processor can refer to the instructions executable on a single hardware processor or the instructions executable on multiple hardware processors.

The machine-readable instructions in the storage medium 508 include runtime policy access instructions 510 to access policy information specifying identifiers of objects subject to runtime attestation. The policy information can be the runtime attestation policy 130 of FIG. 1, for example.

The machine-readable instructions in the storage medium 508 include object monitoring instructions 512 to monitor the objects to detect an access of any object of the objects. The access can include a read access or a write access.

The machine-readable instructions in the storage medium 508 include accessed object measurement instructions 514 to, based on receiving an indication of an access of a first object of the objects, measure the first object to produce a measurement value and record the measurement value in the memory 504 of the security processor 502. The recording of the measurement value can include extending a TPM's PCR with the measurement value, for example.

The machine-readable instructions in the storage medium 508 include attestation data production instructions 516 to produce attestation data including information based on the measurement value for the first object. The attestation data may be obtained by performing a PCR read of a TPM.

The machine-readable instructions in the storage medium 508 include attestation data sending instructions 518 to send the attestation data to an attestation server. The attestation data may be included in a PCR quote, for example.

The machine-readable instructions in the storage medium 508 include attestation result reception instructions 520 to receive a result of an attestation based on the attestation data from the attestation server. The attestation result may be based on verifying a PCR quote, a PCR replay based on the log, and comparing the measurement values in the log to reference measurement values performed by the attestation server.

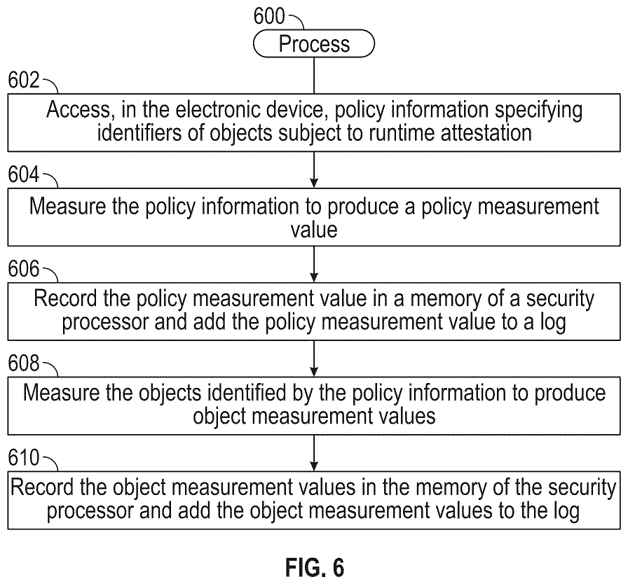

FIG. 6 is a flow diagram of a process 600 according to some examples of the present disclosure. The process 600 may be performed in the electronic device 102 of FIG. 1, for example, such as during an initial phase of the electronic device 102.

The process 600 includes accessing (at 602), in the electronic device, policy information specifying identifiers of objects. The policy information identifies the objects that are to be subjected to runtime attestation.

The process 600 includes measuring (at 604) the policy information to produce a policy measurement value. For example, a cryptographic hash function can be applied on the policy information to generate a policy hash value.

The process 600 includes recording (at 606) the policy measurement value in a memory of a security processor and adding the policy measurement value to a log. For example, the runtime attestation monitor 120 of FIG. 1 can extend a TPM's PCR using the policy measurement value.

The process 600 includes measuring (at 608) the objects identified by the policy information to produce object measurement values. For example, the cryptographic hash function can be applied on the objects to generate object hash values. In some examples, the measurement of objects can be of objects accessed during runtime.

The process 600 includes recording (at 610) the object measurement values in the memory of the security processor and adding the object measurement values to the log. For example, the runtime attestation monitor 120 of FIG. 1 can extend a TPM's PCR using the object measurement values.

The log and the recording of the policy measurement value and the object measurement values are used for an attestation of the objects by an attestation server.

As used here, a “processing resource” can include one or more hardware processors. Examples of electronic devices can include any or some combination of the following: a desktop computer, a notebook computer, a tablet computer, a server computer, a vehicle, a household appliance, or any other type of electronic device.

Examples of storage devices include any or some combination of the following: a disk-based storage device, a solid-state drive, or any other type of storage device. Examples of memory devices include any or some combination of the following: a dynamic or static random access memory (DRAM or SRAM) device, an erasable and programmable read-only memory (EPROM) device, an electrically erasable and programmable read-only memory (EEPROM) device, or a flash memory device.

FIGS. 2, 3, and 6 are flow diagrams of processes including tasks performed in depicted orders. In other examples, the tasks of any of the processes may be performed in a different order, some of the tasks may be omitted, and other tasks may be added.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

A storage medium (e.g., 400 in FIG. 4 or 508 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause an electronic device to:
access policy information specifying identifiers of objects to be attested in the electronic device;
monitor the objects to detect an access of any object of the objects;
based on receiving an indication of an access of a first object of the objects, measure the first object to produce an object measurement value and record the object measurement value in a security processor;
obtain a representation of the object measurement value for the first object from the security processor and send the representation to an attestation server; and
receive a result of an attestation of the first object from the attestation server.

2. The non-transitory machine-readable storage medium of claim 1, wherein the instructions to access the policy information, monitor the objects, measure the first object, obtain the representation of the object measurement value for the first object, and send the representation to the attestation server are in a user space of the electronic device.

3. The non-transitory machine-readable storage medium of claim 1, wherein the identifiers of the objects to be attested specified in the policy information comprise names of the objects.

4. The non-transitory machine-readable storage medium of claim 1, wherein the monitoring of the objects, the measuring of the first object, the obtaining of the representation of the object measurement value for the first object, and the sending of the representation to the attestation server are performed during a runtime of the electronic device.

5. The non-transitory machine-readable storage medium of claim 1, wherein the accessing of the policy information, the monitoring of the objects, the measuring of the first object, and the obtaining of the representation of the object measurement value for the first object are performed by a runtime attestation monitor invoked in response to a boot of the electronic device.

6. The non-transitory machine-readable storage medium of claim 5, wherein the instructions upon execution cause the electronic device to:
discover, by the runtime attestation monitor, the security processor; and
establish, by the runtime attestation monitor, a communication session with the security processor.

7. The non-transitory machine-readable storage medium of claim 5, wherein the instructions upon execution cause the electronic device to:
measure, using an integrity measurement engine, the runtime attestation monitor to verify that the runtime attestation monitor has not been compromised.

8. The non-transitory machine-readable storage medium of claim 7, wherein the instructions upon execution cause the electronic device to:
measure, by the runtime attestation monitor, the policy information to obtain a policy measurement value for the policy information; and
send a representation of the policy measurement value for the policy information to the attestation server to verify that the policy information has not been compromised.

9. The non-transitory machine-readable storage medium of claim 1, wherein the recording of the object measurement value for the first object comprises extending a platform configuration register (PCR) of the security processor using the object measurement value.

10. The non-transitory machine-readable storage medium of claim 9, wherein the representation of the object measurement value for the first object sent to the attestation server comprises a signed PCR quote containing a PCR value based on the object measurement value for the first object.

11. The non-transitory machine-readable storage medium of claim 10, wherein the PCR value is further based on a policy measurement value produced by measuring the policy information.

12. The non-transitory machine-readable storage medium of claim 1, wherein the instructions upon execution cause the electronic device to:
create a log comprising the object measurement value for the first object; and
send the log with the representation of the object measurement value for the first object to the attestation server.

13. The non-transitory machine-readable storage medium of claim 12, wherein the attestation of the first object by the attestation server comprises performing a Platform Configuration Register (PCR) replay using the log, and comparing the object measurement value in the log to a reference object measurement value.

14. The non-transitory machine-readable storage medium of claim 1, wherein the representation of the object measurement value for the first object is sent by an attestation agent in the electronic device to the attestation server, wherein the attestation agent and the attestation server operate according to an open-source attestation protocol.

15. The non-transitory machine-readable storage medium of claim 14, wherein the open-source attestation protocol is a Keylime protocol.

16. The non-transitory machine-readable storage medium of claim 14, wherein the instructions upon execution cause the electronic device to:
register, by the attestation agent using a device identity certificate, with a registrar that operates according the open-source attestation protocol.

17. An electronic device comprising:
a security processor;
a hardware processor; and
a non-transitory storage medium storing instructions executable on the hardware processor to:
access policy information specifying identifiers of objects subject to runtime attestation;
monitor the objects to detect an access of any object of the objects;
based on receiving an indication of an access of a first object of the objects, measure the first object to produce a measurement value and record the measurement value in a memory of the security processor;
produce attestation data comprising information based on the measurement value for the first object;
send the attestation data to an attestation server; and
receive a result of an attestation based on the attestation data from the attestation server.

18. The electronic device of claim 17, wherein the security processor comprises a trusted platform module (TPM), the memory of the security processor comprises a Platform Configuration Register (PCR), and the recording of the measurement value for the first object comprises extending the PCR using the measurement value.

19. A method comprising:
accessing, in an electronic device, policy information specifying identifiers of objects subject to runtime attestation;
measuring, by the electronic device, the policy information to produce a policy measurement value;
recording, by the electronic device, the policy measurement value in a memory of a security processor and adding the policy measurement value to a log;
measuring, by the electronic device, the objects identified by the policy information to produce object measurement values;
recording, by the electronic device, the object measurement values in the memory of the security processor and adding the object measurement values to the log,
wherein the log and the recording of the policy measurement value and the object measurement values are for an attestation of the objects.

20. The method of claim 19, wherein the security processor comprises a trusted platform module, and the memory of the security processor comprises a platform configuration register (PCR),
wherein the recording of the policy measurement value comprises extending the PCR with the policy measurement value, and
wherein the recording of the object measurement values comprises extending the PCR with the object measurement values.
